(19) United States
(12) Patent Application Publication
(10) Pub. No.: US 2013/0276914 A1
(43) Pub. Date: Oct. 24, 2013

(54) PIEZOELECTRIC VALVE AND PUMP ACTUATOR

(71) Applicant: Amnon Kritzman, Karkur (IL)

(72) Inventor: Amnon Kritzman, Karkur (IL)

(73) Assignee: FOUNDER LTD.

(21) Appl. No.: 13/554,510

(22) Filed: Jul. 20, 2012

Related U.S. Application Data
(60) Provisional application No. 61/687,322, filed on Apr. 23, 2012.

(51) Int. Cl. F16K 31/02

(52) U.S. Cl. 137/485; 251/129.01

(57) ABSTRACT

The proposed valves and/or fluid pumps are controlled with a piezoelectric actuator, which provides very low power consumption, low cost, very compact designs, high speed response, long life, hysteresis free and linear operation, long displacement over 50 mm and high torque over 400 Newton. A steady continuous flow of a media is achieved by supplying a power profile to the actuator via an electronic circuitry connected to electrodes attached to the piezoelectric actuator.

### REFERENCE TO PREVIOUS APPLICATIONS

This application claims priority to U.S. provisional patent application No. 61/687,322 filed May 15, 2011 entitled “PIEZOELECTRIC VALVE AND PUMP ACTUATOR”.

### FIELD OF THE INVENTION

The present invention relates to valves and/or fluid pumps controlled with a piezoelectric actuator and providing a replacement or retrofit to valve solenoid control unit.

### BACKGROUND OF THE INVENTION

Most valves and pumps actuated by electromagnetic and solenoid actuator. Some valves are controlled by piezoelectric actuator with limited force and/or stroke in order to control the flow of fluid through the valve system.

Flow control of a flowing fluid through a valve is generally achieved by changing the size of the orifice in the flow line. The change of the orifice size is generally involves moving of an armature up and clown relative to its corresponding valve seat.

The basic operation of proportional solenoid valve: The armature is attracted to the core by an electromagnetic force as the coil is energized, when the applied current varies, the attraction force also varies proportionally to it but not linear and with significant delay and only applied sufficient current due to hysteresis, the flow rate is controlled by the movement (stroke) of the armature, depending on the balance between the attraction force and the spring load.

Solenoid unit is the most common device and method to control valve systems.

However to achieve linear flow control is often difficult to accurately control movement and positioning of the armature valve member through the control voltage or electrical current applied to the solenoids. The reason is the natural characteristics of solenoid and the response of magnetic field in metallic environment. Magnetic field that produced by the solenoid coil is susceptible to variability in their operation due to inductive delays, eddy currents, hysteresis, heat, magnetic saturation, air gap between the solenoid and the armature.

Solenoid base valves are susceptible to the basic construction of the valves which required spring preloads characterized by the varying fluid flow forces.

Other solenoids drawbacks are: current must be continuously supplied to the solenoid in order to maintain the solenoid active, large current has to be provided to switch the solenoid while lower current is required to hold the solenoid in the define. Thus it is requiring a high current power source leads to heating of the solenoid which might be hazardous to some environment in which the solenoid is operated. Although solenoids creates high force it is mostly used against the preload spring, the drawback is that the force produced by a solenoid is dependent on the air gap between the armature and armature, reducing the gap to minimum makes the solenoid production very costly and even so it is not easily controlled by the input signal.

The main drawback is making the solenoid for controlling linear proportional actuator, although proportional solenoids are common, they operate near or at the saturation point and are very inefficient and creates significant limitation for linear valves when it is required high repetition valve actuation rates without delay between the start of the current signal and the start of the armature motion. This is due to the inductive delay between the voltage and magnetic flux required to exert force on the armature. In valve systems, such delays lead to variability.

Prior art of piezoelectric actuators offer the benefit of using little power and linear actuation.

Prior art of piezoelectric actuators do not offer the benefit of using little power miniature pump mechanism.

Furthermore, current piezoelectric valves are configured to have a small holding force that is not suitable for applications requiring large holding force from 150 (hundred and fifty) gram to over 6 (six) kilogram.

### SUMMARY OF THE INVENTION

The present invention overcomes the deficiencies of the background by providing a valves and/or fluid pumps and/or gas pumps and in particular to such valves and/or fluid pumps controlled with linear high force a piezoelectric actuator optionally providing a replacement or retrofit valve solenoid control unit and/or low force piezoelectric valve.

Within the context of this application the term fluid refers to any flowing fluid in various states for example including but not limited to liquids, gases, air or the like.

The present innovation is in the field of valve technologies in order to replace mostly solenoid technologies with new Piezoelectric Actuators (PA) sometimes called Ultrasonic Actuators (UA)

The present invention PA valves offer the industry leading valve performance advancements such as very low power consumption, low cost, very compact designs, high speed response, long life, hysteresis free actuators, linear actuation when dealing with proportional valve, an optional “one to one” kit as a replaceable PA actuator for solenoid actuators.

The new innovation of PA offers unsurpassed quality, performance and range for every application. The PA technology accommodates the most demanding application

The new innovation of PA is designed to meet general industrial standards and capable of long, trouble-free life under stringent operating conditions. The simple construction, utilizing corrosion resistant materials and seal design ensure positive operation and media control. The new innovation of PA availability is in minimum two way flow configurations, different body sizes, and the capability of mounting a variety of interchangeable actuator assemblies to meet any over the counter actuators or for special needs as might be the requirements.

The new innovation offers the state of the art product to overcome the problems of existing proportional flow control solenoid actuators technology or others piezoelectric solutions like the Hoerbiger piezoelectric actuator technology. An optional compact proportional PA valves of this innovation is the added encoder, this construction enables incompatible linear operation with repeatable response and no hysteresis and unknown repeatability and linearity of any existing actuator technologies. The PA innovated technology is designed to be used but not limited in applications such as air blow, flow control, hand piece control for dental unit and other respiratory equipment, as well as, cooling for laser machinery, medical valves, vacuum, steam, oil, harsh chemicals.

The new PA innovation offers low noise construction will result in a quiet operating series of valves that is suitable for a wide variety of applications.

A preferred embodiment of the present invention provides a valve comprising at least one or more controllable piezoelectric actuators. Most preferably the piezoelectric actuators provide a solution for controllable valve where the flows through the valve need to be controlled and predictably controlled in proportion to a control signal. Most preferably the control signal and/or activating energy applied to the piezoelectric actuating module aimed for proportional with the flow through the valve body.

Another preferred embodiment of the present invention provides a valve comprising at least one or more controllable piezoelectric actuators. Most preferably the piezoelectric actuators provide a solution for controllable valve where the required energy, size, heat must be as low as possible while the force is high and cannot achieved by prior arts of solenoids or piezoelectric actuators.

Another preferred embodiment of the present invention provide of piezoelectric valve control module comprises an encoder to increase valve linearity and to ensure resolution of the valve therein minimizing the potential valve no accuracy effect due to some mechanical or electronics tolerances.

Optionally and preferably encoder may be configured to provide a control module for any type of valve and/or valve gating control for example including but not limited to on-off valves, proportional valves or the like.

Most preferably, the valve piezoelectric actuator may be turned on or off without a lag or phase.

Optionally and preferably the valve according to the present invention provides a valve that may exert a holding force of at least about 1 kg or more.

An optional embodiment of the present invention provides a piezoelectric valve that provides a bi-directional piezoelectric actuator that may move a load along a valve stem in response to a control signal.

A preferable embodiment of the present invention provides a piezoelectric valve that does not require a return spring.

An optional embodiment of the present invention provides a piezoelectric control module that may be retrofitting to replace valve gating control modules while maintaining the valve body. Most preferably a plurality of optional valves may be retrofit with the control module of the present invention for example including but not limited to solenoid controlled valves, on-off valves, any off the shelf valve, or the like.

Optionally and most preferably the piezoelectric control module according to the present invention provides a valve gating module that provides a control module that most preferably runs on low energy means. Optionally and most preferably the control module according to the present invention provides for a valve that readily dissipates heat.

An optional embodiment of the present invention provides a piezoelectric control module that may be retrofit with an existing valve to convert it to a proportional valve. For example, an existing on-off valve may be retrofit with a piezoelectric control module according to the present invention to form a proportional valve about the existing valve body. For example, an existing electromagnetic actuator may be replaced with linear piezoelectric actuator.

A preferable embodiment of the present invention provides a piezoelectric controllable valve, utilizing a control signal that utilizes minimal energy less than tens of the energy required by solenoid actuator while providing maximal holding force of 150 gram to over 6 kilogram.

In another embodiment of this invention the piezoelectric actuator is interfaced with a pump configuration module.

Optionally a valve control signal may be provided by at least one or more controller for example including but not limited to an internal controller and/or external controller and/or auxiliary controller, any combination thereof.

Optional is an external controller and/or auxiliary controller may be utilized in conjunction with an internal controller to drive and control the piezoelectric valve according to the present invention. For example, a remote valve control signal may be generated by a user with an external controller and communicated to an internal controller to control the piezoelectric valve according the present invention.

Optionally internal controller may be driven with a power source and/or electronics for example including but not limited to battery, rechargeable battery, induction circuit, mains power supply, electronic circuitry, photovoltaic cells, DC power, AC power, or the like power supply as is known and accepted in the art.

Optionally internal controller may be operate by remote control radiated signals with optional to transmit back the status of the valve and the controller, for this option the power source and/or electronics for example including but not limited to battery, rechargeable battery, induction circuit, mains power supply, electronic circuitry, photovoltaic cells, DC power, AC power, or the like power supply as is known and accepted in the art.

Within the context of this application the term valve stem may be interchangeable with the term armature, shaft, and moveable shaft.

Within the context of this application the term valve gating or valve gating module refers to the member of the valve required for controlling the valve opening and closing.

Within the context of this application the term valve opening refers to the opening between valve seat and valve seal member having a maximum opening equal to the size/length of the valve stem and/or gating module.

Within the context of this application the term valve seal member refers to that portion of the valve which functions to seal and/or close the valve about the valve seat.

Within the context of this application the terms proportional valve opening refers to controlling the valve open/close state in a proportional manner providing for gating the valve in a variable manner between 0 to 100 percent. Optionally the term proportional opening may be interchangeably used with the term non-discrete and/or continuous control of the valve opening of proportional valves can use the term but not limited of linear actuator.

While the invention is described with respect to a limited number of embodiments relating to a valve and especially proportional linear valves, it is to be understood that any valve or pump or the like device may be utilized with the present invention. The valve and/or pump and/or hydraulic pump and/or fluid pump are therefore not limited to the scope and uses described herein below. Embodiments of the present invention may be realized in a number of application involving a valve, pump and/or fluid pump and/or hydraulic pump, for example including but not limited to a valve for gating any flowing fluid (liquids, gasses, oils, plasma) for any application such as medical application, industrial application, automotive industry, healthcare industry, chemical industry, manufacturing, mass production, home-use application, personal application, any combination thereof or the like. For example a valve, valve control module, or a retrofitted valve, according to optional embodiments of the present invention may be utilized in an application for example including but not limited to a faucet valve, an air valve for medical applications, flow control in a mass production line, machinery, fuel injector, or the like.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion, of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1A is a schematic diagram of proportional valve system with external control electronics and the basic parts of the valve internal proportional flow control mechanism.

FIG. 1B is schematic block diagrams of exemplary valves with a piezoelectric valve control module according to the embodiment of the present invention;

FIG. 2 showing a perspective view of two piezoelectric actuator module valve;

FIG. 2A is cross sectional views of an optional piezoelectric control module according to the embodiment of the present invention utilizing two piezoelectric actuators associated with a valve body;

FIG. 3 showing a perspective view of eight piezoelectric actuator module valve;

FIG. 3A is cross sectional views of an optional piezoelectric control module according to the embodiment of the present invention utilizing eight piezoelectric actuators associated with a valve body;

FIG. 4 showing an exploded view of eight piezoelectric valve module;

FIG. 5 showing a single linear piezoelectric actuator;

FIG. 6 showing is cross sectional views of an optional piezoelectric control module according to the embodiment of the present invention utilizing swivel piezoelectric valve module;

FIG. 7 showing the single optional swivel piezoelectric actuator picture as of FIG. 6;

FIG. 8 showing a pump mechanism configuration based on piezoelectric actuator;

### DESCRIPTION OF THE PREFERRED EMBODIMENTS

The principles and operation of the present invention may be better understood with reference to the drawings and the accompanying description. The following figure references labels are used throughout the description to refer to similarly functioning components are used throughout the specification herein below:
1 Valve—of the shelf, modified or new type;
2 Valve housing;
3 Optional encoder unit;
4 Valve seal gasket;
5 Valve outlet fitting connection;
6 Valve body;
7 Valve inlet fitting connection;
9 Valve piezoelectric actuator;
10 Valve piezoelectric actuators stem;
110 Swivel piezoelectric actuator rotational axis shaft;
11 Valve armature and diaphragm seat;
111 Valve seat;
12 Valve diaphragm;
13 Piezoelectric actuator seat plate;
14 Piezoelectric actuator moving ring member;
15 Piezoelectric actuator pivot seat;
16 Piezoelectric actuators housing;
17 Piezoelectric actuator crystal;
170 Swivel piezoelectric actuator crystal;
18 Valve piezoelectric crystal seat;
19 Piezoelectric actuators holder plat;
20 Piezoelectric actuators pivot guide;
21 Piezoelectric actuators moving arm;
22 Piezoelectric actuator pivot;
23 Piezoelectric actuators holder plate actuators fasteners;
24 Piezoelectric actuator arm tip;
25 Piezoelectric actuators stem interface to armature;
250 Swivel piezoelectric actuators axis interface to armature;

Piezoelectric actuators holder plat stern guide;
300 Swivel piezoelectric actuator holder plate and axis shaft guide;
31 Piezoelectric actuators holder stem nut;
33 Piezoelectric actuators cover locking screws;
330 Swivel piezoelectric actuators cover locking screws;
34 Valve body thread holes for cover lock;
35 Piezoelectric actuator cover holes for locking screws;
40 Piezoelectric actuator cover;
400 Swivel piezoelectric actuator cover;
41 Piezoelectric actuator cover electronics place;
42 Piezoelectric actuator optional battery;
43 Piezoelectric actuator electronic control unit;
430 Swivel piezoelectric actuator electronic control unit;
44 Piezoelectric actuator optional encoder electronic;
440 Swivel piezoelectric actuator optional encoder electronic;
45 Piezoelectric actuator optional remote electronic;
71 Receiver antenna of the optional remote electronic 45
47 Optional external electronic control unit;
470 Optional swivel external electronic control unit;
72 Transmitter antenna of the optional external electronic control 47(470)
48 Optional external wiring to electronic control unit;
480 Optional external wiring to swivel electronic control unit;
49 Wiring to external power supply and control signals;
490 Wiring to swivel external power supply and control signals;
51 Piezoelectric actuator optional encoder;
510 Swivel piezoelectric actuator optional encoder;
60 Piezoelectric actuator arms rim fastener;
61 Piezoelectric actuator arms ring;
62 Piezoelectric actuator stem thread;
80 Piezoelectric pump actuator piston stem
81 Piezoelectric pump actuator body
82 Piezoelectric pump actuator piston cylinder
83 Piezoelectric pump actuator diaphragm
84 Piezoelectric pump actuator ring output one way valve
85 Piezoelectric pump actuator input disk one way valve
86 Piezoelectric pump actuator fluid chamber
500 Power and requested control signals unit

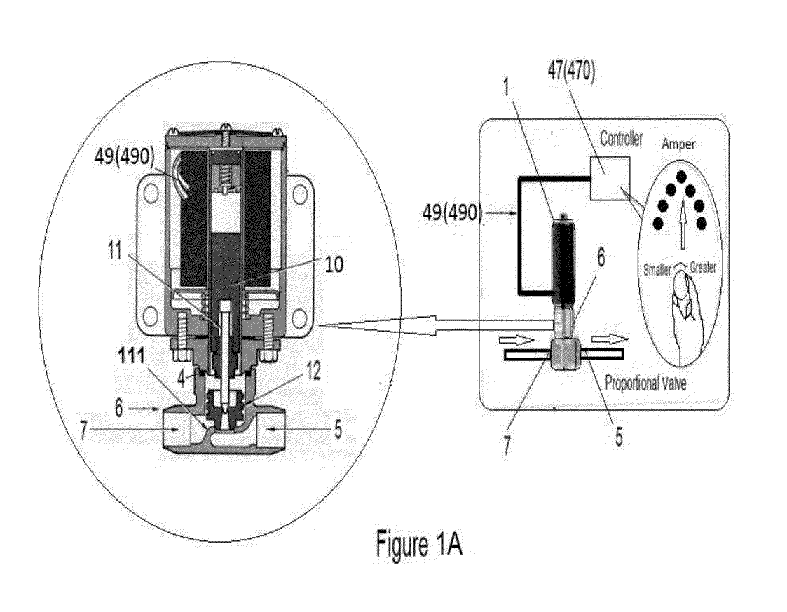

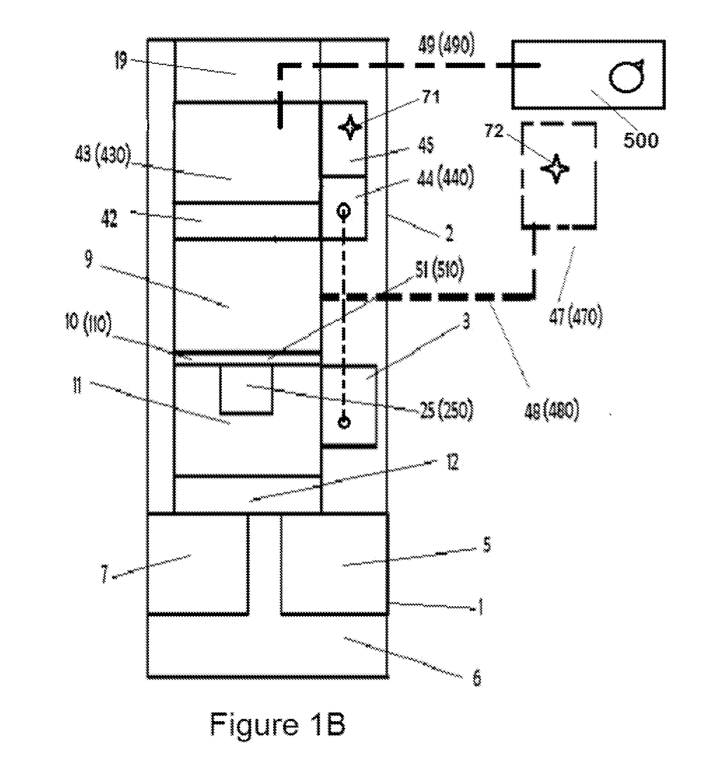

Referring now to the drawings, FIG. 1A is schematic diagram of the general proportional valve configuration. The valve body 1 operation is controlled by changing the input electrical current through the interface controller, the output of the controller by mean of current, voltage, frequency or combination of them according to type of the actuator create movement of the valve stem 11 connected to the valve diaphragm 12 in order to open the valve orifice proportionally to the movement of the diaphragm up and down. The result is proportional controlled out flow at the valve outlet 7 for different pressure at the valve inlet 5. The valve part 6 is sealed from the actuator part by valve seal gasket 4; FIG. 1B is schematic block diagrams of exemplary piezoelectric actuator valve 1 that can be an of the shelf valve body, or modified valve or new valve type 1 comprising the valve body 6, retrofitted with a piezoelectric valve actuators 9 according to the embodiment of the present invention. Most preferably actuators 9 comprise at least one or more piezoelectric actuators and an internal electronic circuitry module 43 most preferably for providing a control signal for at least one or more piezoelectric actuators 9. According to the embodiment of the new invention the valve control electric circuits 43 have an optional internal battery 42, an encoder unit 3 connected to the encoder electronic processor 44 and an optional remote control electronic 45 receiving the control signals through the receiver antenna 71 from the optional external remote electronics 47(470) transmitter antenna 72 enabling to operate the valve wireless and receive by transmission status of the valve and external measurement like flow, pressure, temperature or faults. An optional valve 1 is to have all the electronics part externally to the valve 1 connected by wires to the actuators 9 and the optional encoder 3.

According to the embodiment of this invention the power supply and requested control signals 500 unit is interfacing with the valve electronic module 43 through the cable 49 in order to supply power to the device and submit the requested signals for operation of the piezoelectric actuators 9.

An optional configuration of the valve 1 of FIG. 1 further in the form of optional dual control valve piezoelectric actuators 9 comprising an auxiliary valve control module 47 provided for remotely controlling and/or communicating with valve piezoelectric actuators 9 via an optional auxiliary cable 48.

Optionally, electronic controller 43 may be utilized in conjunction With an internal optional remote module 45 to drive and control the piezoelectric valve actuators 9 according to the present invention. For example, a remote valve control signals may be generated by a user with an auxiliary controller module 47 and communicated directly to the actuators 9 without internal the internal control unit 43 to control the flow through valve housing 6 by adjusting the position of piezoelectric actuators 9 relative to valve armature and diaphragm seat 11 most preferably for linear proportional manner relative to the communicated control signals.

Optionally remote and/or auxiliary control signals may be provided in optional forms for example including but not limited to a computer, mobile communication device, PDA, mobile telephone, robot, android, server, dedicated device, remote control, any combination thereof or the like device comprise processing, communication and power source capabilities. Optionally auxiliary controller module 47 may further comprise a display.

Optionally electronic controller module 43 may communicate a control signal to valve piezoelectric actuators through at least one or more communication protocols and/or technology for example including but not limited to wireless, radio frequency (RF), infrared (IR), optical, wired, near field communication (NFC), far field communication (FTC), RFID technology, acoustic, or any combination thereof.

Optionally the controller module 43 may be controlled manually by a user by interfacing to a voltage or current external source.

According to the embodiment of this invention, see FIG. 1A, the controlled flow and pressure from the inlet 7 to the outlet 5 is done by moving the diaphragm 12 by the valve diaphragm seat and armature 11 relatively to the valve seat 111.

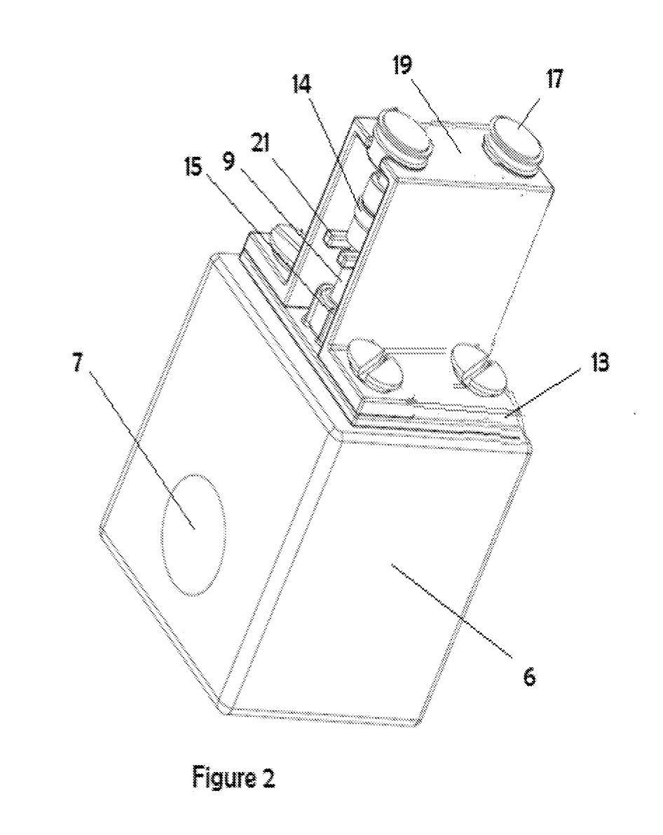

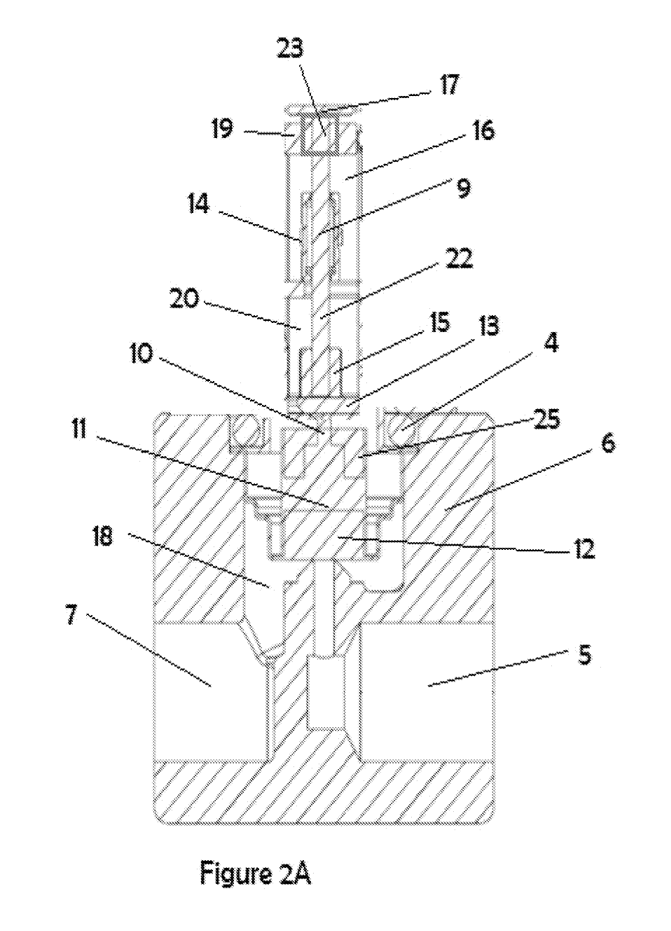

According to the embodiment of this invention keeping the piezoelectric actuators 9, (FIG. 2A) dry and preventing a leak of flow material to this part is done by valve seat gasket 4.

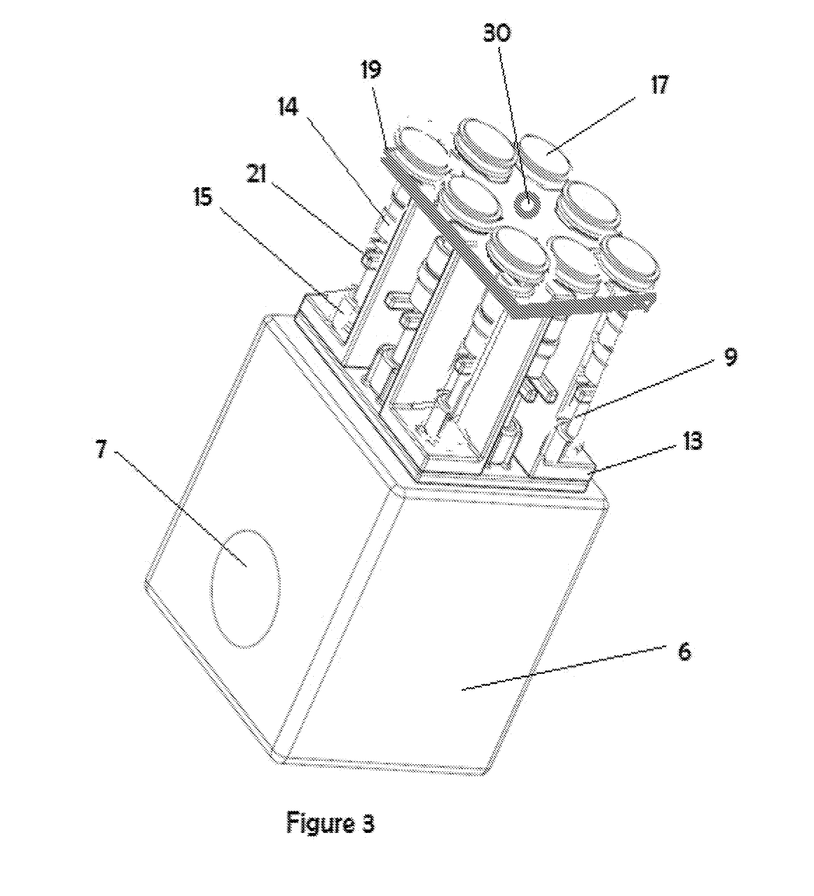

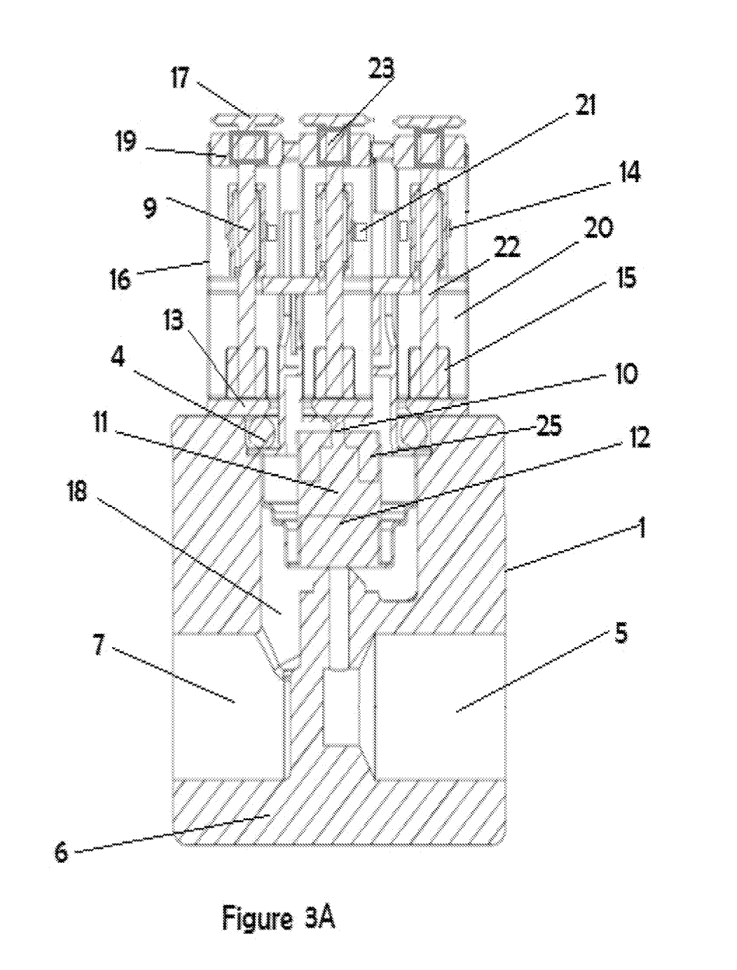

According to the embodiment of this invention of the piezoelectric actuators stem 10 (FIG. 2A and 3A) is connected to the valve armature 11 by the stem armature interface 25 in order to achieve continuous controlled stroke of the diaphragm 12.

FIGS. 2-3 provide schematic illustrations of varying view of valve 1 according to the embodiment of the present invention; FIG. 2 provides a perspective view of valve 1 showing valve actuator housing 16 with a plurality of piezoelectric actuators 9, shown in a two actuator configuration (FIG. 2), according to the embodiment of the present invention. FIG. 3 provides a perspective view of valve 1 showing valve actuator housing 16 with a plurality of piezoelectric actuators 9 (FIG. 3), shown in an eight actuator configuration (FIG. 3), according to the embodiment of the present invention.

FIG. 2A shows a cross-section of valve 1 providing a detail look at the different components of valve 1 with two piezoelectric actuators that provide for a proportional linear controllable valve that most preferably does not exhibit hysteresis effect, overheating, or the like drawbacks of the prior art while maintaining a high holding force of up to about 500 gram.

FIG. 3A shows a cross-section of valve 1 providing a detail look at the different components of valve 1 with eight piezoelectric actuators that provide for a proportional linear controllable valve that most preferably does not exhibit hysteresis effect, overheating, or the like drawbacks of the prior art while maintaining a high holding force of up to about 2 kilogram.

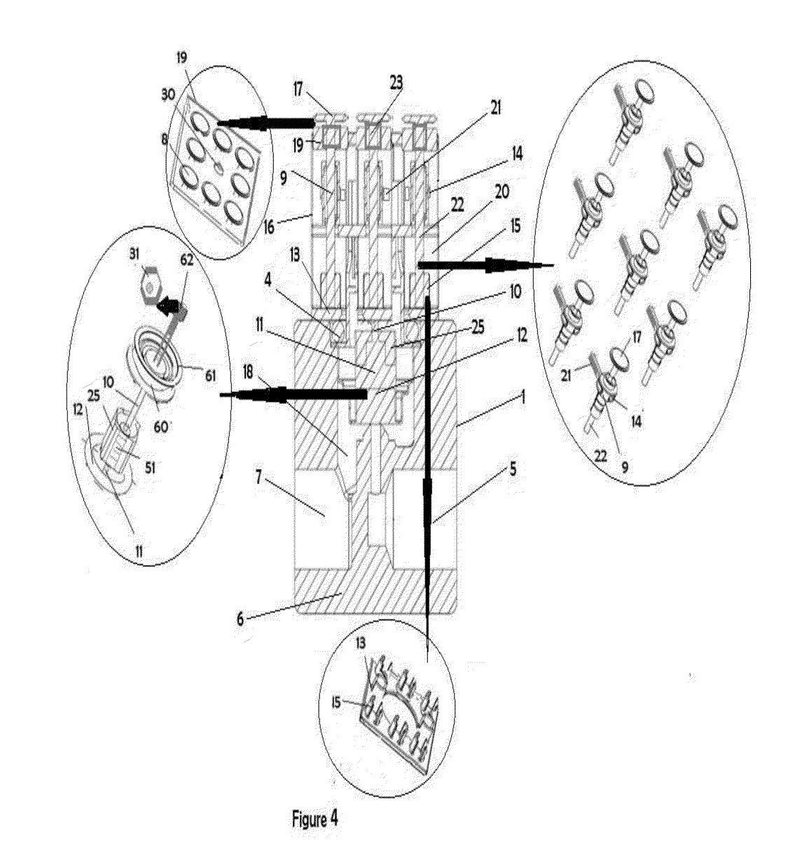

FIG. 4 shows an exploded view of valve 1, further revealing the various components of an optional embodiment of the present invention for piezoelectric valve.

The following description collectively refers to FIGS. 2, 2A, 3 and 3A. Most preferably, valve body 6 includes a valve inlet valve body 7 and valve outlet valve body 5 mediated by a valve seat 111 that may be gated (open and/or closed) optionally and preferably with diaphragm body part 12. Most preferably valve seal member 4 corresponds to and securely fits with and/or over valve seat 111 therein providing securing flow material penetration to the piezoelectric actuators 9 area.

The preferably gating control according to the embodiment of this invention includes at least one and more preferably a plurality piezoelectric actuator 9 provided in the form of actuator that may be securely coupled and/or otherwise associated with actuator housing 16 controlling the valve armature 11 displacement.

Most preferably a plurality of piezoelectric actuators 9 are provided in the form of individual piezoelectric actuator comprising a piezoelectric crystal 17, with an electrode provided for interfacing with the electronic control unit 43; a movable piezoelectric actuator moving ring member 14 coupled on the piezoelectric actuator pivot member 22 thereof with the piezoelectric actuators moving arm 21; In accordance with the embodiment of this invention the piezoelectric actuators moving arm 21 or its coupling fastener to the piezoelectric moving ring member 14 will be detached if the force activated on a single piezoelectric actuator 9 is over 250 gram in order to prevent breakage of the piezoelectric actuator 9 in case of electric disconnection or any other single actuator fault, in this case the maximum holding force will be reduced by 200 gram at the most but the entire unit will continue to be functional. The movable stem 10 is operated in conjunction with stroke of the piezoelectric moving ring member 14 and the piezoelectric actuators moving arms 21 coupled by the piezoelectric actuator arm tip 24 to the piezoelectric actuators stem interface to armature 25.

Most preferably piezoelectric actuator 9 is securely associated with one another provides for converging and/or combining the holding force available with each of the piezoelectric actuators, therein most preferably provided to concertedly act to control valve armature and diaphragm seat 11 by uniformly controlling the position of a common valve stem 10 coupling by the piezoelectric actuators stem interface to armature 25 changing the position of the valve diaphragm 12 relatively to the valve seat 111.

According to the embodiment of this invention the most preferably a control signal may be provided to uniformly control the activity of all piezoelectric actuators 9 utilized and or associated within the valve 1 operating. Optionally, as shown and described with respect to FIG. 1 a control signal may be generated by an internal and/or intrinsic control module and/or circuitry 43, or optionally by an external and/or auxiliary control module 47 or by remote transmitted signals through the remote electronic module 45.

Valve 1 according to the embodiment of this invention preferably comprises, piezoelectric actuators 9 (FIG. 4), piezoelectric actuator seat plate 13, piezoelectric actuator pivot seat 15 for each single piezoelectric actuator, piezoelectric actuators holder plat 19, the holder plate has actuators fasteners 19 for each single piezoelectric member holding the piezoelectric actuator crystal 17. A hole 30 through the actuator holder plat 19 guide the piezoelectric actuator stem 10 and lock it by a nut 31 over the stem thread 62. The piezoelectric actuator control unit is protected by the piezoelectric actuator cover 40 that attached to the valve body 6 through 4 holes 35 and four screws 33 screwed into the valve body threads 34. The cover includes a location for the piezoelectric actuator optional battery 42, the piezoelectric actuator electronic control unit 43, the piezoelectric actuator optional encoder electronic 44 and the piezoelectric actuator optional remote electronic 45. An optional encoder 51 interfacing with the piezoelectric actuator optional encoder electronic 44 will increase accuracy and linearity of proportional flow and pressure.

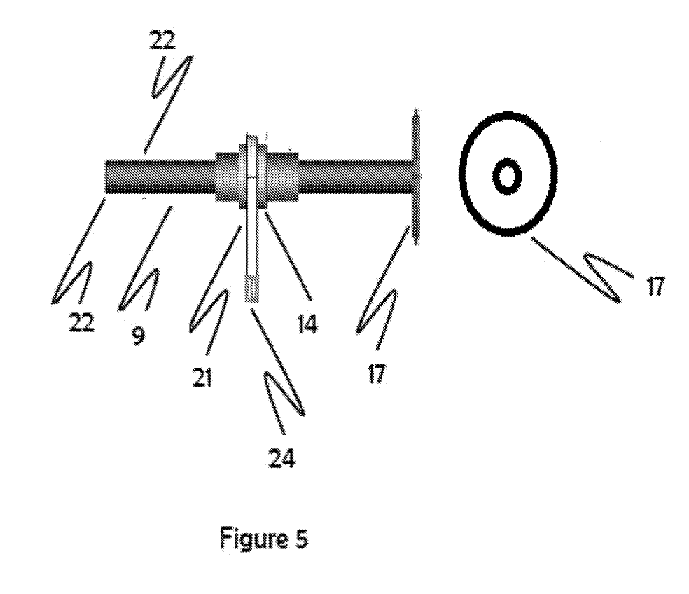

FIG. 5 provide schematic illustrations of one type of piezoelectric actuator 9 and its related parts; the piezoelectric actuator of the embodiment of the invention is constructed from a piezoelectric crystal 17 and a ceramic pivot 22 that transfer the vibration to the piezoelectric actuator moving ring member 14; the piezoelectric actuators moving arm 21 is connected to the piezoelectric moving ring 14 in a way that can stand holding force up to 250 gram, in case that the holding force is beyond 250 gram the moving arm 21 will be detached from the moving ring 14 to prevent damage to the piezoelectric actuator 19 and enable continues of operation of the entire control unit, although with less of 250 gram holding force, the reason is to prevent a single piezoelectric actuator failure due to mechanical or electronics problem to strike completely the valve operation. The piezoelectric actuator moving arm tip 24 is designed to be adapted to the piezoelectric stem 10 by the piezoelectric actuator arms rim fastener 60 of the piezoelectric actuator arms ring 61. One optional type of the piezoelectric actuator 19 of the embodiment of this invention but not the only one is the TULA piezoelectric actuator as in FIG. 5. Operating the Tula's piezoelectric actuator electronic control unit 43 of the Korean Piezoelectric Technology Ltd. Company. Optional parts of the electronic unit are internal battery 42 (FIG. 1), piezoelectric actuator optional encoder electronic 44 connected to the optional encoder 51 in order to increase accuracy and linearity of proportional flow and pressure control and the optional piezoelectric actuator; optional remote electronic 45 enabling to operate and receive valve status information by transmitting and receiving signals by any method and protocols of data transmission.

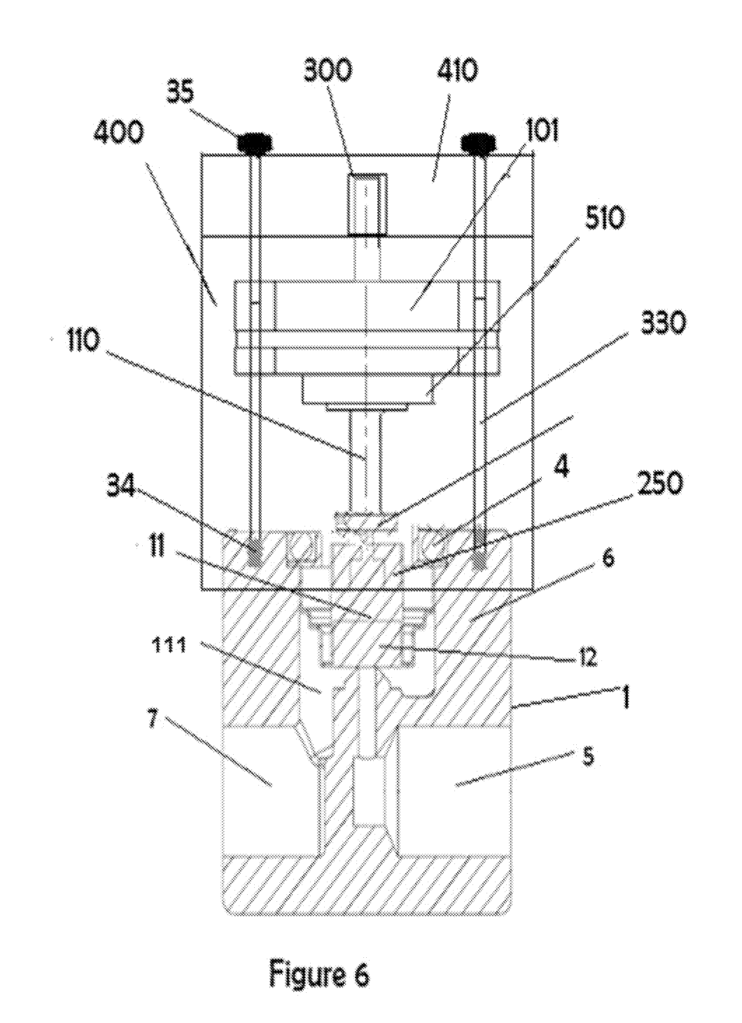

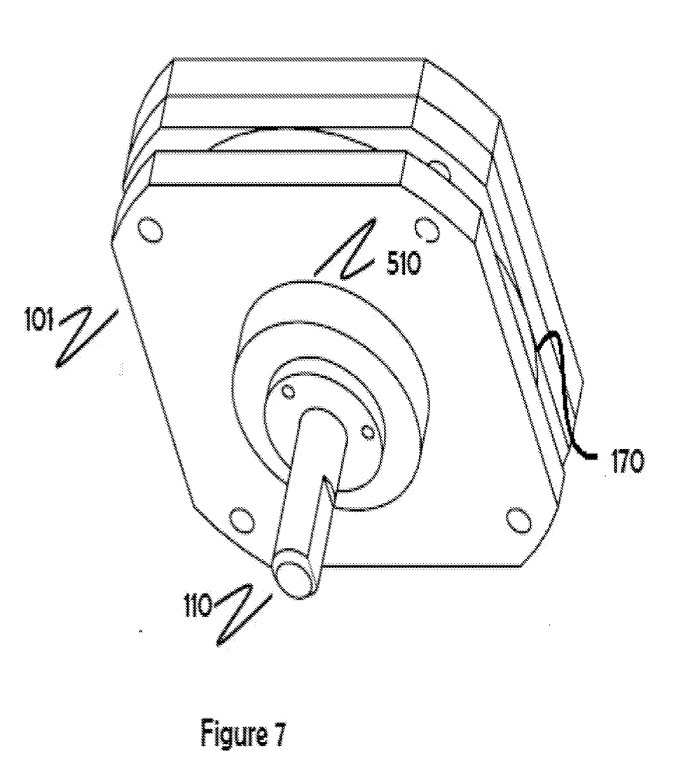

FIG. 6 shows schematic view of a single swivel piezoelectric actuator 101 utilizing for high force up to six kilogram but slow rotational speed of maximum 110 RPM. The swivel piezoelectric actuator has many benefits when high holding force is required and high speed is in less important. According to the embodiment of the invention the valve 1 is similar to other on/off or proportional valves, the moving of the swivel piezoelectric actuator rotational axis shaft 110 interface by the swivel piezoelectric actuators stem interface to armature 250 to the valve armature 11, the swivel piezoelectric actuators axis shaft interface to armature 250 transfers rotational motion to linear motion in order to move the armature 11 up and down proportionally to the control signals from the swivel piezoelectric actuator electronic control unit 430. The swivel piezoelectric actuator 101 is supported by the swivel piezoelectric actuator holder plate and axis shaft guide 300 and by the swivel piezoelectric cover 400 by the four screws 330 going through the cove holes 35 and screwed to the valve body 6 at the thread holes 34. One optional type of the swivel piezoelectric actuator 101 of the embodiment of this invention but not the only one is the PUMR piezoelectric as in FIG. 7. Operating the PUMR's piezoelectric actuator by electronic control unit 430 (FIG. 1B) of the Korean Piezoelectric Technology Ltd. Company; Optional parts of the electronic unit are internal battery 42, piezoelectric actuator optional encoder electronic 440 (FIG. 1B) connected to the optional encoder 510 in order to increase accuracy and linearity of proportional flow and pressure control and the optional piezoelectric actuator; optional remote electronic 45 (FIG. 1B) enabling to operate and receive valve status information by transmitting and receiving signals by any method and protocols of data transmission.

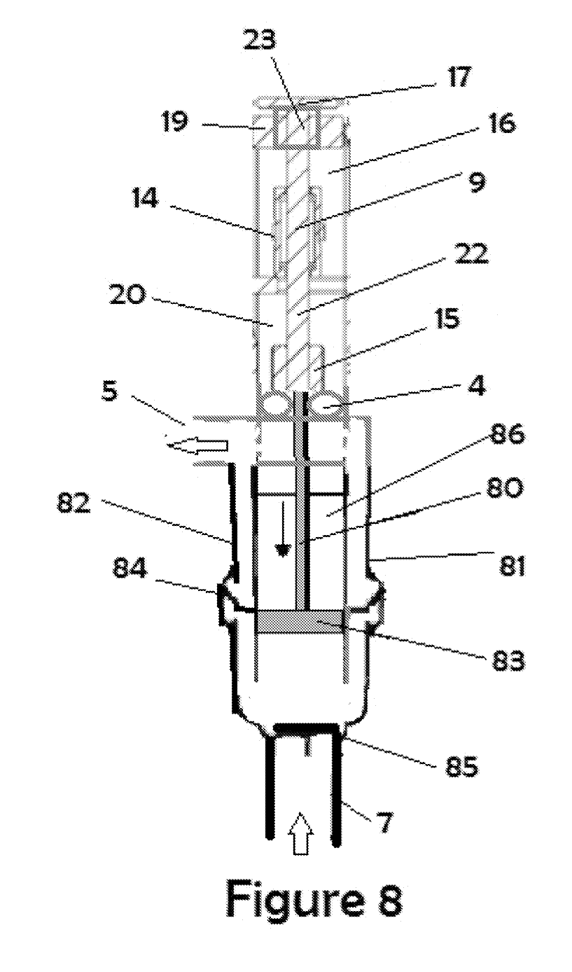

FIG. 8 of this invention showing the use of piezoelectric actuator to operate miniature cylindrical pump, the parts of the piezoelectric actuator is as in piezoelectric valve. By moving the piezoelectric actuator stem 9 repeatable up and down it moves the pump piston 80 of the pump body 81, the diaphragm 83 attached to the piston moves correspondingly, while the diaphragm 83 moves up the one way disk valve 85 is open and the one way ring valve 84 is close, the fluid is filled inside the piezoelectric pump chamber 86 through the inlet 7. When the diaphragm 83 moves down the one way disk valve 85 is close and the one way ring valve 84 is open, the fluid is pushed out to the outlet 5.
While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention defined by the appended claims.

Further modifications of the invention will also occur to persons skilled in the art and all such are deemed to fall within the spirit and scope of the invention as defined by the appended claims.

While the invention has been described with respect to a limited number of embodiments, it will be appreciated that many variations, modifications and other applications of the invention may be made.

1. A device for controlling a flow rate of a media from an inlet to an outlet, comprising:
at least one housing connected to the inlet and the outlet, the housing including at least one piezoelectric actuator, the piezoelectric actuator comprising;
an elastic element positioned between two piezoelectric elements, each on a substrate, said elastic and piezoelectric elements coupled to a movable shaft or pivot member,
a moving ring member that moves along said movable shaft or pivot member,
and an arm member coupled to said moving ring member, said arm member being coupled to a movable valve stem of a valve or pump, wherein said valve stem moves linearly and free of hysteresis in conjunction with said movable ring and arm members when a charge is applied to said piezoelectric actuator, thus creating a given flow rate depending on the applied charge.

2. The device of claim 1, wherein the flow rate change is continuous.

3. The device of claim 2, wherein the flow rate change is proportional to a power profile supplied to said piezoelectric actuator.

4. The device of claim 2, wherein the power profile is provided by an electronic circuitry connected to electrodes attached to the piezoelectric actuator.

5. The device of claim 1, wherein the substrate is elastic.

6. The device of claim 1, wherein the actuator is a single swivel piezoelectric actuator.

7. The device of claim 1, wherein a maximum holding force on a single actuator is up to 250 gram.

8. The device of claim 7, further comprising a safe mechanism preventing the piezoelectric actuator failure when the holding force is above 250 gram.

9. The device of claim 7, wherein the safe mechanism includes detaching a moving ring or a moving arm from a piezoelectric moving part.

10. The device of claim 1, wherein said piezoelectric actuator is remotely controlled by a control unit.

11. The device of claim 10, wherein said control unit further comprises a status block, which collect and displays information from internal or external sensors on the flow rate, pressure, temperature, alarms.

12. The device of claim 1, further comprising a control unit for controlling the actuator operation.

13. The device of claim 12, wherein said control unit includes an encoder unit interfaced to an electronic encoder processor to increase the linearity and an accuracy of the device operation.

14. The device of claim 1, adapted to provide a holding force of about 2 kg when using eight actuators.

15. The device of claim 1, adapted to provide a holding force of about 6 kg when using a single swivel actuator.

16. The device of claim 1, wherein said piezoelectric actuator control unit is powered by low energy source including battery photocell.

17. A piezoelectric actuators module constructed as pumping valve module, comprising: at least one housing connected to the inlet and the outlet, the housing including at least one piezoelectric actuator, the piezoelectric actuator comprising: an elastic element positioned between two piezoelectric elements, each on a substrate, said elastic and piezoelectric elements coupled to a movable shaft or pivot member,
a moving ring member that moves along said movable shaft or pivot member,
and an arm member coupled to said moving ring member, said arm member being coupled to
a movable valve stem of a valve or pump, wherein said valve stem moves linearly and free of hysteresis in conjunction with said movable ring and arm members when a charge is applied to said piezoelectric actuator, thus creating a given flow rate depending on the applied charge, thus achieving an improved operation of the pumping valve module.

18. The control module of claim 18, wherein the improved operation is provided by controlled power profile supplied to said piezoelectric actuator, which is supplied from an electronic circuitry connected to electrodes attached to the piezoelectric.

19. A piezoelectric actuators control module for an Over The Counter (OTC), modified or new, valve provided to control a valve gating module, flow through a valve body with a valve control module, comprising:
at least one piezoelectric motor, the piezoelectric actuator control module including:
a unit adapted for associating with the armature of the valve, and providing access to said valve gating module;
the valve body comprising:
a controllable fluid line with an inlet, an outlet, a valve seat, a valve gating housing having access to said valve seat, said valve gating housing comprising a valve diaphragm member corresponding to said valve seat to control the flow of a flowing fluid from said inlet to said outlet and at least one piezoelectric actuator for controlling the movement of said valve diaphragm relative to said valve seat;
wherein each of said piezoelectric actuators is linear piezoelectric or swivel piezoelectric actuator;
and wherein said at least one piezoelectric actuator is securely associated with said valve control unit via a movable armature; and
wherein said movable armature is coupled to and operates in conjunction with said valve diaphragm; and
wherein said valve gating module is controllable with electronic circuitry for controlling the power profile applied to the said valve at least one piezoelectric actuator about said piezoelectric electrical wiring therein controlling the movement of said valve diaphragm relative to said valve seat about said movable armature interfaced to the actuator.
